(19) United States
(12) Patent Application Publication
(10) Pub. No.: US 2017/0147159 A1
(43) Pub. Date: May 25, 2017

(54) CAPTURING AND STORING DYNAMIC PAGE STATE DATA

(71) Applicant: International Business Machines Corporation, Armonk, NY (US)

(72) Inventors: Deniz T. Efendioglu, San Francisco, CA (US); Paul E. Reimer, San Francisco, CA (US); Elwin K. Sam, San Francisco, CA (US)

(21) Appl. No.: 14/946,673

(22) Filed: Nov. 19, 2015

(51) Int. Cl. G06F 3/0482; G06F 17/22; H04L 29/08

(52) U.S. Cl. CPC G06F 3/0482; H04L 67/02; H04L 67/1097; G06F 17/2247

(57) ABSTRACT

Methods and systems may provide for detecting a request to store a particular state of a web page and conducting a capture of user triggered state data corresponding to one or more dynamic elements of the web page in response to the request. Additionally, the user triggered state data may be sent to a page gallery server. In one example, the one or more dynamic elements change in response to user input.

### BACKGROUND

Embodiments of the present invention generally relate to the management of web page state data. More particularly, embodiments relate to capturing and storing dynamic page state data.

Analytical software may be used to determine how customers/consumers interact with web pages. In order to view the analytical results, however, users of the software may navigate to a specific web page each time they wish to view a report concerning that page. For example, in order to analyze a checkout page, the user might add an item to a cart and navigate to the checkout page in order to view the analytical report. Such an approach may be cumbersome and/or tedious from the perspective of the analytical software user. Moreover, the analytical report may take into consideration only the initial state of the checkout page. Because the appearance and/or content of the checkout page may change during the checkout process (e.g., in response to user input), the analytical report may fail to capture and/or convey all relevant interaction information.

### BRIEF SUMMARY

Embodiments may include an analytics enhancement apparatus comprising a browser monitor to detect a request to store a particular state of a web page, a snapshot controller communicatively coupled to the browser monitor, the snapshot controller to conduct a capture of user triggered state data corresponding to one or more dynamic elements of the web page in response to the request, and an upload manager communicatively coupled to the snapshot controller, the upload manager to send the user triggered state data to a page gallery server.

Embodiments may also include a computer program product to manage page states, the computer program product comprising a computer readable storage medium having program instructions embodied therewith, the program instructions executable by a computer to cause the computer to retrieve a web page from a web server, detect a request to store a particular state of the web page, conduct a capture of user triggered state data corresponding to one or more dynamic elements in the web page in response to the request, wherein the capture is to include a retrieval of the user triggered state data from a document object model associated with the web page, the user triggered state data is to include one or more of markup language data, stylesheet data or image data, and the one or more dynamic elements are to change in response to user input, send the user triggered state data to a page gallery server that is separate from the web server, initiate a gallery session with the page gallery server, and retrieve a plurality of page state submissions from the page gallery during the gallery session.

Embodiments may also include a method comprising retrieving a web page from a web server, detecting a request to store a particular state of the web page, conducting a capture of user triggered state data corresponding to one or more dynamic elements of the web page in response to the request, wherein conducting the capture includes retrieving the user triggered state data from a document object model associated with the web page, the user triggered state data includes one or more of markup language data, stylesheet data or image data, and the one or more dynamic elements change in response to user input, sending the user triggered state data to a page gallery server that is separate from the web server, initiating a gallery session with the page gallery server, and retrieving a plurality of page state submissions from the page gallery server during the gallery session.

### BRIEF DESCRIPTION OF THE SEVERAL VIEWS OF THE DRAWINGS

The various advantages of the embodiments of the present invention will become apparent to one skilled in the art by reading the following specification and appended claims, and by referencing the following drawings, in which:

FIG. 1 is an illustration of an example of a web page having dynamic elements according to an embodiment;

FIG. 2 is an illustration of an example of a gallery session interface according to an embodiment;

FIG. 3 is an illustration of an example of a heat map overlay according to an embodiment;

FIG. 4 is a flowchart of an example of a method of managing page states according to an embodiment;

FIG. 5 is a flowchart of an example of a method of presenting analytical results according to an embodiment;

FIG. 6 is a block diagram of an example of a networking architecture according to an embodiment;

FIG. 7 is a block diagram of an example of an analytics enhancement apparatus according to an embodiment; and

FIG. 8 is a block diagram of an example of a computing system according to an embodiment.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in at least one particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

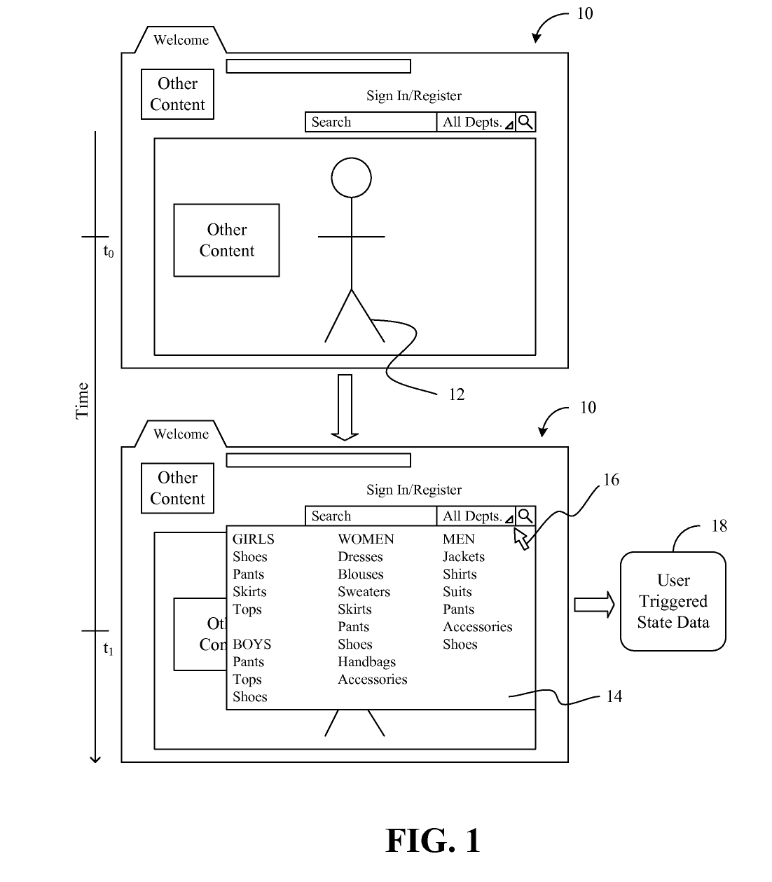

Turning now to FIG. 1, a web page 10 is shown, wherein the appearance and/or content of the web page 10 may generally change in response to user input. For example, at time t₀, an image 12 might be fully visible on the web page 10, whereas at time t₁, the image 12 may be partially obscured by dynamic elements such as, for example, a hover menu 14. The display of the hover menu 14 may be triggered by user input such as, for example, the placement of a cursor 16 over or near a portion of the web page 10 that is associated with the hover menu 14. As will be discussed in greater detail, user triggered state data 18 associated with the hover menu 14 may be captured and used to present analytic results. The user triggered state data 18 may include, for example, markup language data (e.g., Hypertext Markup Language/HTML data, Extensible Markup Language/XML data), stylesheet data (e.g., Cascaded Style Sheet/CSS data), image data, and so forth. The user triggered state data 18 may also be associated with other dynamic elements such as, for example, web application elements, scripted form fields, etc., as well as other content on the web page 10. The user triggered state data 18 may be assigned an identifier and sent/posted to a page gallery server for storage and/or future viewing.

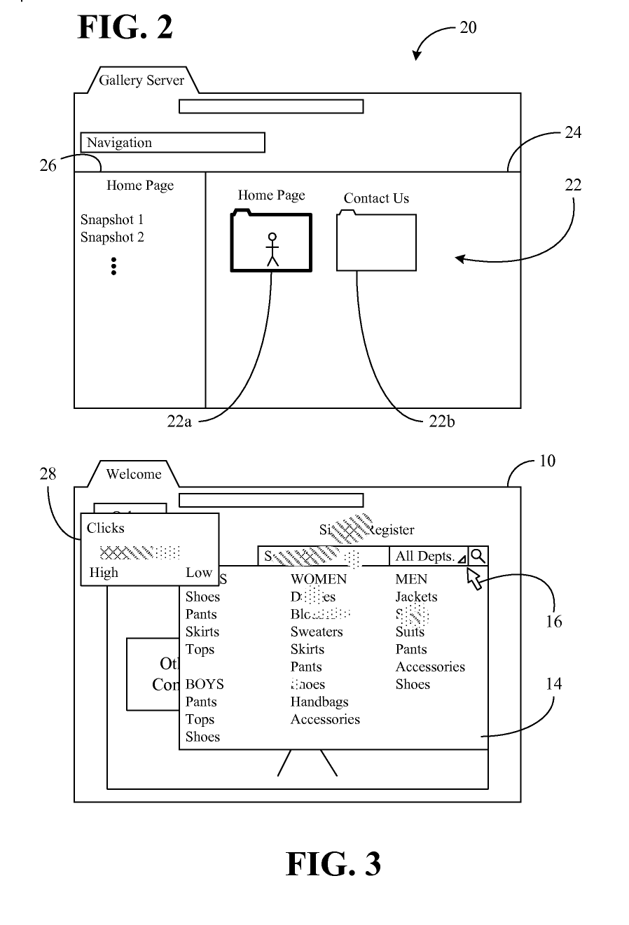

FIG. 2 shows a gallery session interface 20 in which a set of thumbnails 22 (22a, 22b) are displayed in a gallery frame 24 of the interface 20. Each thumbnail 22 may generally correspond to a page of a web site. For example, a first thumbnail 22a might correspond to a “Home Page” such as, for example, the web page 10 (FIG. 1), a second thumbnail 22b may correspond to a “Contact Us” page, and so forth. Selection of the thumbnails 22 may cause one or more snapshots from the selected thumbnail to be listed in a details frame 26 of the interface 20. In the illustrated example, the first thumbnail 22a has been selected, which results in the listing of a plurality of snapshots (“Snapshot 1”, “Snapshot 2”) in the details frame 26. Each snapshot may represent a different state of the Home Page, wherein one or more of the states may be triggered by user input (e.g., causing dynamic elements on the page to change).

FIG. 3 shows a heat map overlay example in which the web page 10 is reproduced along with additional analytical information. More particularly, a legend 28 may indicate the visual mappings between user clicks and the content visible on the web page 10. In the illustrated example, the user triggered state data (e.g., markup language data, stylesheet data, image data, etc.) of the hover menu 14 as well as other visible content on the web page 10 is overlaid with heat map data. Accordingly, the user is able to view analytical information for the web page 10 at different moments in time (e.g., times t₀ and t₁ in FIG. 1). The heat map data may be obtained from statistical and/or crowd based sources of web browsing data (e.g., backend systems and/or databases).

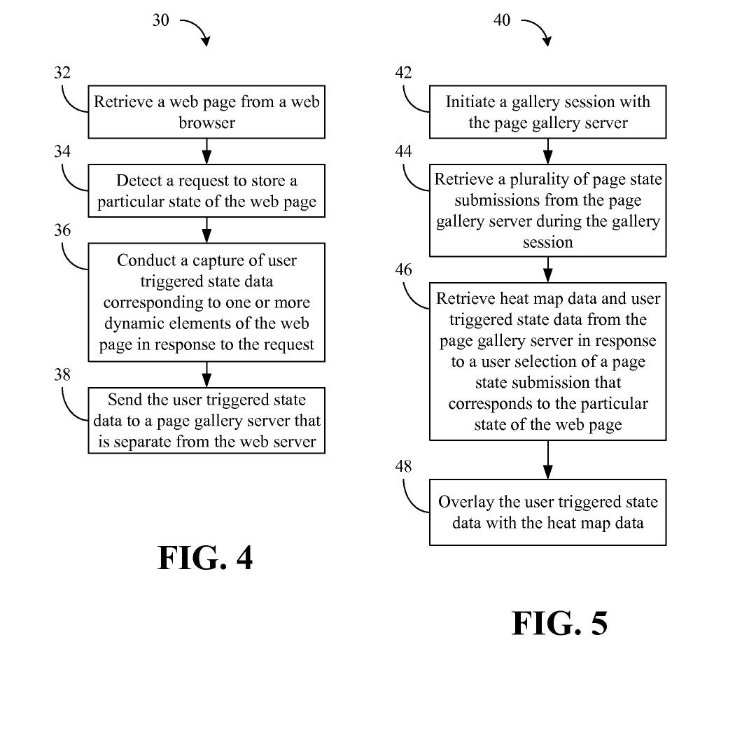

Turning now to FIG. 4, a method 30 of managing page states is shown. The method 30 may be implemented as software, hardware, firmware, etc., or any combination thereof. Illustrated processing block 32 provides for retrieving a web page from a web server, wherein block 34 may detect a request to store a particular state of the web page. The request may be detected via a menu selection, command or other suitable signal/message. A capture of user triggered state data may be conducted at block 36 in response to the request. In the illustrated example, the user triggered state data corresponds to one or more dynamic elements such as, for example, a hover menu, web application element, scripted form field, and so forth. Block 36 may include retrieving the user triggered state data from a document object model (DOM) associated with the web page.

In this regard, the DOM may be a cross-platform and language-independent convention for representing and interacting with objects in the web page and the dynamic elements may be implemented via scripts that make real-time changes to the DOM. In one example, block 36 involves excluding one or more script elements (e.g., JAVASCRIPT, VBSCRIPT, DART) of the web page from the capture. Excluding the script elements may simplify the capture, normalize the snapshot, and ensure that snapshots remain unchanged after collection. The user triggered state data may be sent at block 38 (e.g., along with an associated identifier) to a page gallery server that is separate from the web server. Isolating the user triggered state data may further ensure that snapshots remain unchanged after collection.

FIG. 5 shows a method 40 of presenting analytical results. The method 40 may be implemented in software, hardware, firmware, etc., or any combination thereof. Illustrated processing block 42 provides for initiating a gallery session with a page gallery server. Block 44 may retrieve a plurality of page state submissions (e.g., snapshot listings) from the page gallery server during the gallery session. Heat map data and user triggered state data may be retrieved from the page gallery server (or other suitable source) at block 46 in response to a user selection of a particular page state submission (e.g., a submission that corresponds to a particular state of the web page). Illustrated block 48 overlays the user triggered state data with the heat map data.

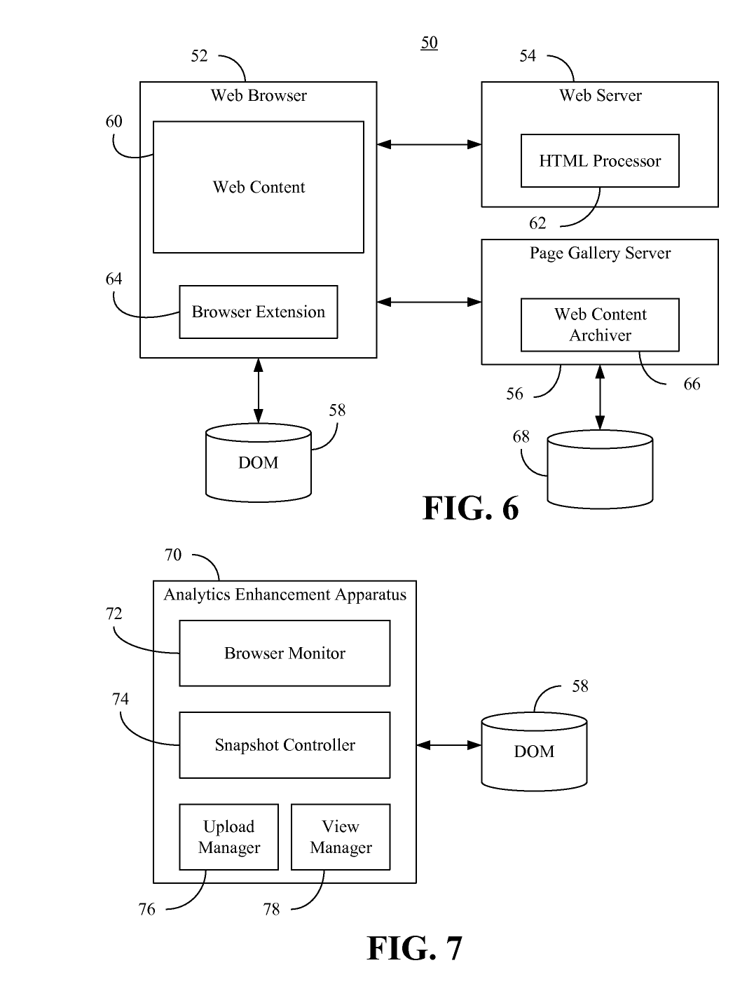

Turning now to FIG. 6, a networking architecture 50 is shown in which a web browser 52 accesses and/or communicates with a web server 54, a page gallery server 56 and a DOM 58. The web browser 52 may generally obtain web content 60 from an HTML processor 62 of the web server 54. The web browser 52 may also include a browser extension 64 that captures user triggered state data corresponding to dynamic elements in the web content 60. In one example, the browser extension 64 captures the user triggered state data by accessing the DOM 58. The browser extension 64 may also send/post the user triggered storage data to the page gallery server 56, which may use a web content archiver 66 to store the user triggered state data to a gallery database 68.

FIG. 7 shows an analytics enhancement apparatus 70 that may be used to manage page states and present analytical results. The apparatus 70, which may include software, hardware, firmware, etc., or any combination thereof, may therefore implement one or more aspects of the method 30 (FIG. 4) and/or the method 40 (FIG. 5), already discussed. The apparatus 70 may also be readily substituted for the browser extension 64 (FIG. 6), already discussed. In the illustrated example, the apparatus 70 includes a browser monitor 72 to detect a request to store a particular state of a web page. The request may be detected via a menu selection, command or other suitable signal/message. Additionally, a snapshot controller 74 may be communicatively coupled to the browser monitor 72, wherein the snapshot controller 74 is configured to conduct a capture of user triggered state data corresponding to one or more dynamic elements of the web page in response to the request. The one or more dynamic elements may change in response to user input and the user triggered state data may include markup language data, stylesheet data, image data, etc., or any combination thereof. In one example, at least one of the dynamic element(s) includes a hover menu. Moreover, the capture may include a retrieval of the user triggered state data from a DOM associated with the web page. The snapshot controller may also exclude (e.g., remove) one or more script elements of the web page from the capture.

The apparatus 70 may also include an upload manager communicatively coupled to the snapshot controller 74 to send the user triggered state data to a page gallery server. As already noted the page gallery server may be separate from the web server. In one example, a view manager 78 initiates a gallery session with the page gallery server and retrieves a plurality of page state submissions from the page gallery server during the gallery session. Each of the plurality of page state submissions may correspond to a different user triggered state of the web page. The view manager 78 may also retrieve heat map data and the user triggered state data from the page gallery server in response to a user selection of a page state submission that corresponds to the particular state of the web page and overlay the user triggered state data with the heat map data.

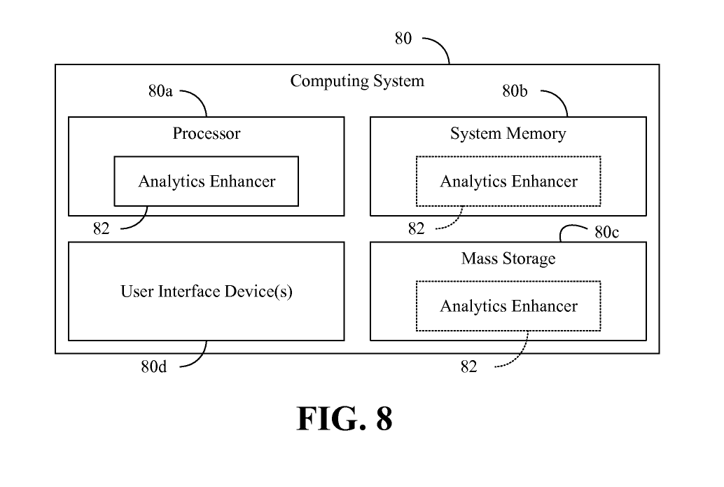

FIG. 8 shows a computing system 80 (80a-80d) that may be used to manage page states and present analytics results. In the illustrated example, a processor 80a operates an analytics enhancer 82, which may optionally be obtained from system memory 80b and/or mass storage 80c of the computing system 80. The analytics enhancer 82 may cause the computing system 80 to operate similarly to the analytics enhancement apparatus 70 (FIG. 6), already discussed. Accordingly, the analytics enhancer 82 may be configured to detect requests to store particular states of a web page, conduct captures of user triggered state data corresponding to one or more dynamic elements of the web page in response to the requests, and send the user triggered state data to a page gallery server. Additionally, the analytics enhancer 82 may present a combination of the user triggered state data with heat map data via one or more user interface devices 80d (e.g., display, speaker, monitor).

Thus, techniques described herein may obviate any need for users to repeatedly navigate sites or search through saved sessions to locate pages to be analyzed. Additionally, thumbnail representations of snapshots may facilitate easier and faster identifications of captured pages. Moreover, users may view the exact state of a page—including the assets displayed and any dynamic elements that have been activated—at the time the capture was taken. Snapshots of the page may also be stored until the user deletes them. Since they are being stored separately from the original web site, the snapshots may be unaffected if the page is taken down and/or if the corresponding assets are modified.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A computer program product to manage page states, the computer program product comprising a computer readable storage medium having program instructions embodied therewith, the program instructions executable by a computer to cause the computer to:
retrieve a web page from a web server;
detect a request to store a particular state of the web page;
conduct a capture of the user triggered state data corresponding to one or more dynamic elements in the web page in response to the request, wherein the capture is to include a retrieval of the user triggered state data from a document object model associated with the web page, the user triggered state data is to include one or more of markup language data, stylesheet data or image data, and the one or more dynamic elements are to change in response to user input;
send the user triggered state data to a page gallery server that is separate from the web server;
initiate a gallery session with the page gallery server; and
retrieve a plurality of page state submissions from the page gallery server during the gallery session.

2. The computer program product of claim 1, wherein the one or more dynamic elements are to include one or more of a hover menu.

3. The computer program product of claim 1, wherein each of the plurality of page state submissions corresponds to a different user triggered state of the web page.

4. The computer program product of claim 3, wherein the program instructions, when executed, cause a computer to:
retrieve heat map data and user triggered state data from the page gallery server in response to a user selection of a page state submission that corresponds to the particular state of the web page; and
overlay the user triggered state data with the heat map data.

5. The computer program product of claim 4, wherein the program instructions, when executed, cause a computer to exclude one or more script elements of the web page from the capture.

6. A method comprising:
retrieving a web page from a web server;
detecting a request to store a particular state of the web page;
conducting a capture of user triggered state data corresponding to one or more dynamic elements of the web page in response to the request, wherein conducting the capture includes retrieving the user triggered state data from a document object model associated with the web page, the user triggered state data includes one or more of markup language data, stylesheet data or image data, and the one or more dynamic elements change in response to user input;
sending the user triggered state data to a page gallery server that is separate from the web server;
initiating a gallery session with the page gallery server; and
retrieving a plurality of page state submissions from the page gallery server during the gallery session.

7. The method of claim 6, wherein at least one of the one or more dynamic elements includes a hover menu.

8. The method of claim 6, wherein each of the plurality of page state submissions corresponds to a different user triggered state of the web page.

9. The method of claim 8, further including:
retrieving heat map data and user triggered state data from the page gallery server in response to a user selection of a page state submission that corresponds to the particular state of the web page; and
overlaying the user triggered state data with the heat map data.

10. The method of claim 6, further including excluding one or more script elements of the web page from the capture.

11. An apparatus comprising:
a browser monitor to detect a request to store a particular state of a web page;
a snapshot controller communicatively coupled to the browser monitor, the snapshot controller to conduct a capture of user triggered state data corresponding to one or more dynamic elements of the web page in response to the request; and
an upload manager communicatively coupled to the snapshot controller, the upload manager to send the user triggered state data to a page gallery server.

12. The apparatus of claim 11, wherein the one or more dynamic elements are to change in response to user input.

13. The apparatus of claim 12, wherein at least one of the one or more dynamic elements is to include a hover menu.

14. The apparatus of claim 11, wherein the capture is to include a retrieval of the user triggered state data from a document object model associated with the web page.

15. The apparatus of claim 11, wherein the user triggered state data is to include one or more of markup language data, stylesheet data or image data.

16. The apparatus of claim 11, further including a view manager to initiate a gallery session with the page gallery server and retrieve a plurality of page state submissions from the page gallery server during the gallery session.

17. The apparatus of claim 16, wherein each of the plurality of page state submissions are to correspond to a different user triggered state of the web page.

18. The apparatus of claim 17, wherein the view manager is to retrieve heat map data and the user triggered state data from the page gallery server in response to a user selection of a page state submission that corresponds to the particular state of the web page and overlay the user triggered state data with the heat map data.

19. The apparatus of claim 11, wherein the snapshot controller is to exclude one or more script elements of the web page from the capture.

20. The apparatus of claim 11, further including a page requester to retrieve the web page from a web server that is separate from the page gallery server.
